(19) United States
(12) Patent Application Publication
(10) Pub. No.: US 2026/0193082 A1
(43) Pub. Date: Jul. 9, 2026

(54) METHOD FOR OPERATING A CRACKING PROCESS

(71) Applicant: BASF SE, Ludwigshafen am Rhein (DE)

(72) Inventors: Daniel KECK, Ludwigshafen am Rhein (DE); Rombout KELDERMANS, Antwerpen (BE); Pieter REYNIERS, Ludwigshafen am Rhein (DE); David VAN CAUWENBERGE, Antwerp (BE); Joerg UNGER, Ludwigshafen am Rhein (DE); Stefan DAHMEN, Ludwigshafen am Rhein (DE)

(21) Appl. No.: 19/133,080

(22) PCT Filed: Nov. 28, 2023
(86) PCT No.: PCT/EP2023/083370

§ 371 Date: May 27, 2025

(30) Foreign Application Priority Data
Nov. 28, 2022 (EP) 22209839.4

(51) Int. Cl. C01B 3/28; C10G 9/24; C10G 9/36

(52) U.S. Cl. CPC C01B 3/28; C10G 9/24; C10G 9/36; C01B 2203/0272; C01B 2203/062; C01B 2203/08; C01B 2203/1235; C01B 2203/1258; C01B 2203/84

(57) ABSTRACT

A method for operating a cracking process produces a cracked gas from which one or more product streams and one or more hydrocarbon-containing by-product-streams are recovered. The method comprises subjecting at least one of the by-product-streams or a partial stream thereof to a hydrocarbon-to-hydrogen conversion process to produce a hydrogen product stream; and combusting at least a part of the hydrogen product stream to provide thermal energy to the cracking process, wherein the hydrocarbon-to-hydrogen conversion process is a moving bed hydrocarbon pyrolysis process. The plant set-up enables the use of hydrogen firing for providing thermal energy as a full or partial replacement of firing fossil resources such as natural gas as in prior art processes.

The present invention relates to a method for operating a cracking process.

Several basic chemical processes are associated with inherent CO₂ emissions which are unavoidable or difficult to avoid or reduce. Often, these emissions stem from endothermal processes which require high temperatures. High temperature hydrocarbon conversion processes such as steam crackers, ammonia plants, steam reformers are examples for these processes. While process heat up to 300 to 400° C. can readily be supplied through high-pressure steam or direct electrical heating, high temperature heating is currently achieved through natural gas firing which is inherently accompanied by CO₂ emissions. Although the overall CO₂ emissions of these processes are high, the concentration of CO₂ in the emitted flue-gas from firing is rather low. The effort to absorb CO₂ and permanently remove it from the atmosphere requires that large volumes of gas be treated, which in itself is energy intensive and thus generates CO₂.

Direct firing with hydrogen would avoid CO₂ emissions. However, the availability of emission-free hydrogen from renewable energy sources is still limited today.

Hydrogen can be produced from natural gas as well as from gaseous waste streams containing hydrocarbons, especially aliphatic hydrocarbons, using reforming technologies (e.g. in a Steam Methane Reforming (SMR), autothermal reforming (ATR), or partial oxidation (POX)) which split the C—H bonds and generate hydrogen, CO and CO₂, or, put otherwise, which oxidize the carbon to CO and CO₂ and generate hydrogen. The off-gas of these processes has a high concentration of CO₂. Thus, CO₂ can be captured with higher efficiency and lower intrinsic energy demand from these processes. Methane pyrolysis is a technology that splits natural gas, bio-methane, and/or hydrocarbons, especially aliphatic hydrocarbons directly into the components hydrogen and solid carbon in the absence of oxygen-transferring agents such as H₂O or CO₂.

Ethylene and propylene are important feedstocks used in the production of numerous petrochemical intermediate products and end products. They are made by cracking ethane, propane, or sometimes heavier paraffins or naphthas with steam at high temperature. The material to be cracked is diluted with an inert gas, usually steam, and heated to 700 to 900° C. for a very short time. The gas mixture leaving the cracker is typically a mixture of hydrogen, methane, hydrocarbons and carbon dioxide, of which 10 to 40% of the gas may be ethylene produced by reactions such as

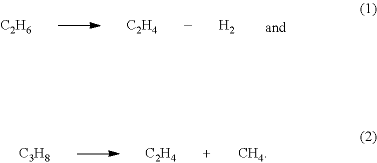

After the carbon dioxide and other acid gases have been removed, the hydrogen and methane must be separated from the other gases. The conventional method involves compressing the gas mixture to 3.4 MPa and cooling to below −100° C. This separates the C₂₊ components from the hydrogen and methane, followed by a series of distillation operations that produce the various fractionated hydrocarbon streams. As with all cryogenic separations, the removal of the hydrogen and methane is complicated and costly.

Although crackers are the main source of low molecular-weight olefins, similar streams containing hydrogen, some methane, and potentially useful amounts of ethylene and propylene are produced in a number of refinery operations. A typical source of such gas streams is fluid catalytic cracking (FCC). Since the primary goal of the refinery is not olefin production, it is usually not cost-effective or convenient to separate the olefins, which remain in a stream that is often simply burnt as fuel.

While the refinery gases are a potential source of hydrogen, many refinery gas streams are not used for their hydrogen content due to a variety of economic and practical reasons. For instance, the economics for separating hydrogen from refinery gases that contain less than about 30% hydrogen are generally unfavorable.

Notwithstanding the above, DE 10 2016 209 155 discloses a reduced CO₂-emission or zero CO₂-emission process for producing olefins by steam cracking, comprising providing a gas mixture using one or more tubular reactors and producing a predominantly or exclusively hydrogen-containing fraction using the gas mixture.

Hydrogen combustion heat generated by firing the predominantly or exclusively hydrogen-containing fraction or a portion thereof is supplied to the tubular reactor or to at least one of the plurality of tubular reactors.

EP 3 249 027 discloses a reduced emission process for the production of olefins by steam cracking using one or more tubular reactors. At least one of the tubular reactors is heated both using combustion heat generated by firing at least one fuel and using electric heat generated by means of electric energy. The heat of combustion may be generated at least in part by burning a hydrogen-rich gas mixture.

The hydrogen-rich gas mixture may be formed using one or more gas mixtures provided by the one or more tubular reactors.

EP 3 202 710 discloses a process for the chemical reaction of one or more hydrocarbon reactants with the supply of steam and heat, wherein the steam and heat are supplied at least in part using at least one burner to which a first fluid stream (a) containing predominantly or exclusively oxygen, a second fluid stream (b) containing predominantly or exclusively hydrogen and a third fluid stream (c) containing predominantly or exclusively steam are supplied. Hydrogen may be formed during the chemical reaction, at least part of which is separated and transferred to the second fluid stream (b).

EP 3 189 122 discloses a method for the at least substantially CO₂-free operation of a first production plant producing a low-CO₂ and H₂-rich product gas or off-gas from a carbon-containing feed wherein the low-CO₂ and H₂-rich product gas or off-gas is fed to a gas treatment plant which divides the product gas or off-gas into a carbon-containing, at least substantially H₂-free gas substream and an at least substantially carbon-free, H₂-rich gas substream and the substantially H₂-free gas substream is at least partly fed to one or more firing device(s) of the first production plant, where at least part of the CO₂-containing off-gas stream formed in the firing device(s) is at least partly fed to a device for producing a CO₂-rich gas stream, where hydrogen (H₂) and oxygen (O₂) are produced by electrolysis of water in a water electrolysis plant and methanol and/or downstream products of methanol are produced in a second production plant and, firstly, the CO₂-rich gas stream is at least partly fed to the second production plant and, secondly, the H₂-rich gas substream and/or the hydrogen (H₂) produced in the water electrolysis plant is at least partly fed to the second production plant.

WO 2021/205011 discloses a process for producing ethylene from a hydrocarbon feed, comprising
cracking the hydrocarbon in a cracking furnace of an ethylene plant to produce a cracked hydrocarbon-containing gas, comprising ethylene, hydrogen and methane;
separating at least part of the cracked hydrocarbon-containing gas at least into an ethylene-enriched product, a hydrogen-enriched fuel and a methane-enriched fuel;
feeding at least part of the hydrogen-enriched fuel from the separation section to a burner of the cracking furnace and/or feeding at least part of the hydrogen-enriched fuel from the separation section to a burner of a waste heat recovery boiler of a combined cycle gas turbine power plant (CCGT);
feeding at least part of the methane-enriched fuel, obtained directly from the separation section as a liquid or after liquefying a gaseous methane-enriched fuel stream from the separation section, to a methane storage;
feeding at least part of the methane-enriched fuel from the storage to the combustor of the CCGT wherein said methane-enriched fuel from the storage is vaporized before it is fed into the combustor; and
subjecting the vaporized methane-enriched fuel fed to the combustor of the CCGT, to combustion in the CCGT, thereby generating electric power and/or thereby generating (high pressure) steam for driving a steam turbine forming part of a steam generation circuit of the ethylene plant, wherein at least a part of the power is electric power produced from a renewable source.

EP 4 029 924 describes a process for integrating pyrolysis and gas or liquid cracking comprising: a) supplying a hydrocarbon feed to a pyrolysis unit; b) pyrolyzing the hydrocarbon feed thereby generating a first product stream comprising hydrogen and unreacted hydrocarbons; c) using the first product stream as a fuel for at least one cracker furnace included in a cracker unit; d) collecting a second product stream comprising hydrogen and hydrocarbons from the cracker unit; and e) supplying the second product stream to the pyrolysis unit.

WO 2022/200256 describes a system to produce olefins including a pre-heating assembly to heat a hydrocarbon feed and/or dilution steam, and cracking furnaces in flow communication with the pre-heating assembly. At least one cracking furnace may be powered by hydrogen to generate heat to crack the hydrocarbon feed and/or the dilution steam into cracked hydrocarbons including olefins and methane. The system also may include a pyrolyzer in flow communication with at least one of the cracking furnaces to split methane from the cracked hydrocarbons into carbon black and hydrogen. At least a portion of the hydrogen from the pyrolyzer may be supplied to at least one cracking furnaces as fuel.

A plant set-up which enables the use of hydrogen firing in the chemical process would lead to lower overall CO₂ emissions. In addition, if H₂ is derived from renewable sources/renewable energy, the CO₂ emission of such a plant set-up can be reduced even further. It is therefore an object of the present invention to enable a sustainable use of cracker by-product-streams, in particular to ensure flexibility in view of fluctuating or changing hydrogen and hydrocarbon contents in the cracker by-product stream. Preferably, the carbon is trapped in a solid state without emitting it to the atmosphere. Further in this connection, it is desirable that the carbon is obtained in an easy-to-transport granular form.

In addition, in order to be able to modify or upgrade existing cracker assets it is desirable that the hydrocarbon-to-hydrogen conversion process be largely energetically self-contained or heat-integrated.

The conversion of cracker by-product streams such as the demethanizer over-head stream into hydrogen is, however, not without challenges. A main problem is that, generally speaking, the composition of the cracker by-product streams is ill-defined. Even though the cracker by-product streams may comprise a majority of methane, they usually further comprise hydrogen and/or C₂₊ hydrocarbons depending on the type of cracker feed and the severity of cracking conditions. This includes a situation where in addition to the demethanizer over-head stream, other low value hydrocarbon streams emanating from the cracker are directed to the hydrocarbon-to-hydrogen conversion process. Furthermore, the composition of the cracker by-product stream may fluctuate over time. Hence, changes to the hydrocarbon-to-hydrogen conversion process controls may be required when cracker operation is shifted to different types of cracker feedstock and these changes may interfere with the continuous and/or efficient operation of the hydrocarbon-to-hydrogen conversion process.

Irrespective of the range of cracker by-product stream compositions and changing cracker by-product streams cracker by-product streams, a hydrogen stream with a low concentration of minor components, except for methane, is desirable.

Hence, the invention relates to a method for operating a cracking process which produces a cracked gas from which one or more product streams and one or more hydrocarbon-containing by-product-streams are recovered, the method comprising: subjecting at least one of the by-product-streams or a partial stream thereof to a hydrocarbon-to-hydrogen conversion process to produce a hydrogen product stream; and
combusting at least a part of the hydrogen product stream to provide thermal energy to the cracking process,
wherein the hydrocarbon-to-hydrogen conversion process is a moving bed hydrocarbon pyrolysis process.

The present invention involves combusting at least part of hydrogen product stream to provide all or part of the thermal energy for the cracking process. In other words, the plant set-up of the present invention enables the use of hydrogen firing for providing thermal energy as a full or partial replacement of firing fossil resources such as natural gas as in prior art processes. Generally, combusting hydrogen yields water as the only by-product. Thus, advantageously, the method of the present invention allows for an emission-reduced operation of the cracking process. Herein, by the term “emission-reduced operation” is meant that the method of the invention is operated in such a way that the emission of greenhouse gases such as carbon dioxide is avoided or at least reduced. In other words, the method of the present invention advantageously allows for an operation under a reduced carbon footprint.

It has been found that the moving bed hydrocarbon pyrolysis process is a robust and reliable technology which can accommodate fluctuations in the composition of the feed gas. It is not necessary to remove the hydrogen from the feed gas before it is fed to the moving bed hydrocarbon pyrolysis process. Also, consumption of hydraulic capacity by excess hydrogen in in the feed gas is not a problem. The process cannot only tolerate the presence of C₂₊ hydrocarbons in the feed gas but the C₂₊ hydrocarbons are efficiently converted into hydrogen without the requirement of a pre-reformer or similar unit. The moving bed hydrocarbon pyrolysis process is especially favorable as it allows for adjusting its process conditions without the necessity of process interruptions, i.e. without the necessity of process shut-downs.

### Cracking

The present invention relates to a cracking process. Cracking is a petrochemical process wherein saturated hydrocarbons having long molecular structures are broken down, i.e. cracked, into smaller saturated or unsaturated molecules. Generally, crackers aim at producing light alkenes as valuable products, especially ethylene and propylene. Cracking processes include fluid catalytic cracking (FCC) and steam cracking. In a preferred embodiment, the cracking process is a steam cracking process.

### Steam Cracking

Conventional steam cracking utilizes a pyrolysis furnace which has two main sections: a convection section and a radiant section. The hydrocarbon feedstock typically enters the convection section of the furnace as a liquid, or, in a case where light feedstocks are used, as a vapor, wherein it is typically heated and, if necessary, vaporized by indirect contact with hot off-gas from the radiant section and by direct contact with steam. The vaporized feedstock and steam mixture is then introduced into the radiant section where the cracking takes place.

The resulting stream having a temperature typically in the range of from 500 to 650° C. enters a fired tubular reactor and is heated to a temperature typically in the range of from 700 to 900° C. for 0.1 to 0.5 s, wherein the residence time, temperature profile and partial pressure is controlled. During this short reaction time, hydrocarbons in the feedstock are cracked into smaller molecules yielding light olefins such as ethylene, propylene, butylenes, other small olefins, and diolefins as major products besides methane. These reaction products suitably typically leave the radiant tube at a temperature in the range of 800 to 850° C. and are preferably cooled to a temperature typically in the range of from 550 to 650° C. within 0.02 to 0.1 s in order to prevent degradation of the highly reactive compounds by secondary reactions. Then, the resulting reaction products leave the furnace for further downstream processing.

### Fluid Catalytic Cracking

In fluid catalytic cracking (FCC), a particulate catalyst, often having a particle size in the range of from 20 to 100 μm, circulates between a cracking reactor and a catalyst regenerator. In the reactor, a hydrocarbon feed contacts the hot, regenerated catalyst. The hot catalyst vaporizes and cracks the feed typically at 425 to 600° C.

The cracking reaction deposits carbonaceous hydrocarbons, which eventually turn to coke on the catalyst, thereby deactivating it. The cracked products are separated from the coked catalyst, usually with the aid of a catalyst stripper, and the stripped catalyst is then regenerated within the regenerator. A catalyst regenerator burns coke from the catalyst with oxygen containing gas, usually air. Regeneration of the catalyst by oxidation restores catalyst activity and simultaneously typically heats the catalyst to 500 to 900° C. The heated catalyst is recycled to the cracking reactor to crack more fresh hydrocarbon feed. Catalytic cracking is an endothermic reaction. Suitably, the heat for cracking and vaporization of the feed is supplied by the hot regenerated catalyst from the regenerator. According to the invention, this includes that the thermal energy generated by combustion of at least a part of the hydrogen product stream may be provided to the regenerator.

### Cracker Feedstock

The hydrocarbon feedstock introduced into the cracker may originate from upstream refinery processes such as an atmospheric distillation tower, hydrocracker, coker etc. and typically contains naphtha, liquefied petroleum gas (LPG), ethane, propane and/or butane. Alternatively or additionally, the hydrocarbon subjected to the cracking process may be selected from natural gas, recyclate, bio-based gas, bio-naphtha, or bio-liquefied petroleum gas (bio-LPG).

The term “natural gas” encompasses a naturally occurring mixture of gaseous hydrocarbons which primarily consists of methane in addition to small amounts of other higher alkanes such as ethane, propane etc. Natural gas is a fossil fuel and thus a non-renewable source of energy.

The term “recyclate” encompasses pyrolysis oils obtained by pyrolysis of recycled plastic waste materials. Thus, recyclate is a renewable source of energy.

The term “bio-based gas” encompasses is a mixture of gases, primarily consisting of methane besides carbon dioxide and hydrogen sulfide which is produced from raw materials such as agricultural waste, manure, municipal waste, plant material, sewage, green waste, food waste etc. Thus, bio-based gas is a renewable source of energy.

The term “naphtha” encompasses liquid hydrocarbon mixtures produced from natural gas condensates, petroleum distillates, and the distillation of coal tar and peat. Thus, naphtha is a non-renewable source of energy.

The term “bio-naphtha” encompasses naphtha produced from complex mixtures of naturally occurring fats and oils. Thus, bio-naphtha is a renewable source of energy.

The term “liquefied petroleum gas (LPG)” encompasses a fuel gas containing a flammable mixture of hydrocarbon gases, in particular propane and butane. Liquefied petroleum gas is prepared by refining petroleum or “wet” natural gas. Thus, liquefied petroleum gas is a non-renewable source of energy.

The term “bio-liquefied petroleum gas (bio-LPG)” encompasses liquefied petroleum gas produced from complex mixtures of naturally occurring fats and oils. Thus, bio-naphtha is a renewable source of energy.

### Processing of the Cracked Gas

Herein, the designator “Cₓ” refers to a hydrocarbon including x carbon atoms, “Cₓ₊” refers to a hydrocarbon or mixture of hydrocarbons including x or greater carbon atoms, and “Cₓₘᵢₙᵤₛ” refers to a hydrocarbon of mixture of hydrocarbons including x or fewer carbon atoms.

Usually, the resulting reaction mixture comprising light olefins such as ethylene, propylene, butylenes, other small olefins, and diolefins besides methane is separated by using a sequence of separation and chemical-treatment steps. The process typically also generates light side products such as hydrogen, carbon oxides, light saturated hydrocarbons, and water. Suitably, the resulting product-of-interest streams (hereinafter referred to as “product streams”), especially ethylene and propylene, are either used directly in downstream processes or stored in storage vessels for subsequent use or long-term storage.

As the products of interest from the cracked gas are separated, i.e., condensed or distilled out, one or more hydrocarbon-containing by-product streams, such as off-gas streams, having little commercial value remain. These streams are collectively referred to as hydrocarbon-containing by-product-streams herein. These by-product-streams contain at least one hydrocarbon which may be selected from methane, saturated hydrocarbons, in particular saturated C₂ to C₃ hydrocarbons, or C₅₋₉ hydrocarbons. The by-product-streams may contain hydrogen in addition to these hydrocarbons. In an embodiment, the by-product-stream includes methane as a main hydrocarbon constituent, e.g., at least 75 wt.-% of methane, preferably at least 85 wt.-% of methane, relative to the hydrocarbons comprised in the by-product-stream. These by-product-streams have conventionally been burnt as fuel gas or else recycled as feedstock to the cracker unit.

The hot cracked gas leaving the cracker is cooled down quickly in order to prevent unwanted follow-up reactions. This is usually done in several steps. In a first step, the cracked gas is cooled down to about 450° C. by heat exchangers. A further cooling step occurs via direct contact between the cracked gas and a high boiling liquid, usually referred to as quench oil. The quench results in a partial condensation of the cracked gas. In this step, a heavy stream rich in C₁₀₊ hydrocarbons is separated from the cracked gas. A further cooling step of the cracked gas takes place in a water quench column for primary fractionation, cooling down the gas to around 30° C. In this step, a C₅₋₉ fraction, commonly referred to as pyrolysis gasoline, is separated from C₄ₘᵢₙᵤₛ components.

The pyrolysis gasoline may be hydrogenated to remove olefinic unsaturation and sent to benzene extraction. Extractive benzene separation may be performed in an extractive distillation column. For this purpose, the pyrolysis gasoline or, more preferably, the hydrogenated pyrolysis gasoline, is introduced into the extractive distillation column and benzene is absorbed by means of a suitable absorbent such as N-methylpyrrolidone (NMP). In the extractive distillation column, a bottom product obtained from NMP with dissolved benzene is discharged to a benzene stripper. The overhead vapor from the extractive distillation flows to the raffinate column in order to recover NMP. The NMP with some dissolved hydrocarbons is discharged back to the extractive distillation column. The top product from the raffinate column mainly contains saturated hydrocarbons and qualifies as a by-product-stream to be subjected to hydrocarbon-to-hydrogen conversion.

The heavy stream rich in C₁₀₊ hydrocarbons as well as pyrolysis gasoline, either before or after hydrogenation or benzene extraction may be used as a by-product-stream subjected to the hydrocarbon-to-hydrogen conversion process.

Hence, in a preferred embodiment, the method involves a quench of hot cracked gas with a high-boiling liquid, wherein a heavy stream comprising C₁₀₊ hydrocarbons is separated from the cracked gas, and a water quench, wherein pyrolysis gasoline is separated from the cracked gas, optionally subjecting the pyrolysis gasoline to hydrogenation, optionally subjecting the hydrogenated pyrolysis gasoline to extractive separation of benzene, and subjecting at least one of the heavy stream, the pyrolysis gasoline, the hydrogenated pyrolysis gasoline and the benzene-depleted hydrogenated pyrolysis gasoline or a partial stream thereof as the by-product-stream to the hydrocarbon-to-hydrogen conversion process.

The recovery of the various olefin products from cracked gas is usually carried out by fractional distillation using a series of distillation steps or columns to separate out the various components. The unit which separates hydrocarbons with one carbon atom (C₁) and lighter fraction is referred to as “demethanizer”. The unit which separates hydrocarbons with two carbon atoms (C₂) from the heavier components is referred to as “deethanizer”. The unit which separates the hydrocarbon fraction with three carbon atoms (C₃) from the heavier components is referred to as “depropanizer”. The unit which separates the hydrocarbon fraction with four carbon atoms (C₄) from the heavier components is referred to as “debutanizer.”

The residual heavier components having a higher carbon number fraction (C₅₊) may be used as gasoline or recycled back to the cracker. Alternatively, they may be sent as a by-product-stream to the hydrocarbon-to-hydrogen conversion process.

The various fractionation units may be arranged in a variety of sequences in order to provide desired results based upon various feedstocks. To that end, a sequence which uses the demethanizer first is commonly referred to as the “front-end demethanizer” sequence. Similarly, when the deethanizer is used first, it is commonly referred to as the “front-end deethanizer” sequence. And, when the depropanizer is used first, it is commonly referred to as “front-end depropanizer” sequence.

In the conventional front-end demethanizer sequence, the cracked gas containing hydrocarbons having one to five or more carbon atoms per molecule (C₁ to C₅₊) first enters a demethanizer, where methane and lighter fractions (hydrogen) are separated as an over-head stream. The demethanizer operates at relatively low temperatures, typically ranging from about −100° C. to about 25° C.

The front-end demethanizer over-head stream constitutes a suitable by-product-stream to be directed to the hydrocarbon-to-hydrogen conversion process. Alternatively, hydrogen contained in the front-end demethanizer over-head stream may be removed first and the remaining gas consisting mainly of methane is directed to the hydrocarbon-to-hydrogen conversion process.

The heavy ends exiting the demethanizer consist mainly of C₂ to C₅, molecules. These heavy ends then are routed to a deethanizer where the C₂ hydrocarbons are taken over the top and the C₃ to C₅, compounds leave as bottoms. The C₂ components leaving the top of the deethanizer may be fed to an acetylene converter or acetylene removal unit. As some methane remains dissolved in the heavy ends exiting the demethanizer and ends up in the C₂ components leaving the deethanizer, the C₂ components stream may be subsequently sent to a demethanizer for removal of the remaining methane. This residual demethanizer over-head stream constitutes a suitable off-gas stream to be directed to the hydrocarbon-to-hydrogen conversion process.

Hence, in a preferred embodiment, the method comprises recovery of the product streams from the cracked gas by a series of distillation steps including at least one demethanizer, in which methane and lighter fractions, including hydrogen, are separated as an over-head stream, optionally separating the over-head stream to obtain a hydrogen rich stream and a methane rich stream, and subjecting the over-head stream or the methane rich stream or partial streams thereof as the by-product-stream to the hydrocarbon-to-hydrogen conversion process.

The over-head stream from the demethanizer comprises methane and hydrogen as the main components. The ratio of methane and hydrogen in the over-head stream may vary depending on the cracking operation, respectively the cracking feedstock (see for example Ullmann's Encyclopedia of Industrial Chemistry, Ethylene 5.1.3 Commercial Cracking Yields, DOI: 10.1002/14356007.a10_045.pub3 for different cracking yields depending on different cracker feedstocks) but the methane content is generally in the range of from 40 to 95 wt.-%, preferably 90 to 95 wt.-% of methane, with the remainder being mainly hydrogen.

In an embodiment, the over-head stream is separated into a hydrogen rich stream and a methane rich stream. Preferably, the methane rich stream has a methane content of at least 96 wt.-%, more preferably at least 98 wt.-%, most preferably at least 99-wt. %, in particular at least 99.9 wt.-%. Preferably, the hydrogen rich stream has a hydrogen content of at least 90 wt.-%, more preferably at least 95 wt.-%. The methane rich stream or at least parts thereof are subjected as the by-product stream to the hydrocarbon-to-hydrogen conversion process. The hydrogen rich stream or at least a part thereof is combined with the hydrogen product stream and subjected to combustion to provide thermal energy to the cracking process.

Separation of hydrogen and methane can be achieved by pressure swing adsorption.

The C₂ components from which methane has been removed are then sent to a C₂ splitter which produces ethylene as the light product and ethane as the heavy product. The C₃ to C₅, stream leaving the bottom of the deethanizer is routed to a depropanizer, which sends the C₃ components overhead and the C₄ to C₅, components below.

The C₃ product may be hydrotreated to remove C₃ acetylene and dienes before being fed to a C₃ splitter, where it is separated into propylene at the top and propane at the bottom.

Both ethane from the C₂ splitter and propane from the C₃ splitter constitute by-product-streams that may be directed to the hydrocarbon-to-hydrogen conversion process.

Hence, in a preferred embodiment the method comprises recovery of the product streams from the cracked gas by a series of distillation steps including a separation of saturated and unsaturated C₂ hydrocarbons in a C₂ splitter and/or separation of saturated and unsaturated C₃ hydrocarbons in a C₃ splitter, and subjecting the saturated C₂ hydrocarbons and/or the saturated C₃ hydrocarbons or a partial stream thereof as the by-product-stream to the hydrocarbon-to-hydrogen conversion process.

The C₄ to C₅, stream is fed to a debutanizer, which produces C₄ components at the top with the balance of C₅, components leaving as bottoms. Both the C₄ and the C₅, streams may be separately hydrotreated to remove undesirable acetylenes and dienes.

In conventional front-end deethanizer sequences, the cracked gas containing C₁ to C₅₊ components first enters a deethanizer. The light ends exiting the deethanizer consist of C₂ and C₁ components along with any hydrogen (C₂ₘᵢₙᵤₛ fraction). These light ends are fed to a demethanizer (C₂ₘᵢₙᵤₛ demethanizer) where the hydrogen and C₁ are removed as light ends and the C₂ components are removed as heavy ends. The C₂ stream leaving the bottom of the demethanizer may be fed to an acetylene converter and then to a C₂ splitter which produces ethylene as the light product and ethane as the heavy product. The heavy ends exiting the deethanizer which consist of C₃ to C₅₊ components are routed to a depropanizer which sends the C₃ components over-head and the C₄ to C₅₊ components below. The C₃ product is fed to a C₃ splitter where it is separated into propylene at the top and propane at the bottom, while the C₄ to C₅₊ stream is fed to a debutanizer which produces C₄ compounds at the top with the balance leaving as bottoms to be used for gasoline or to be recirculated as feed into the cracking process. As with the front-end demethanizer sequence, the C₃, C₄, and C₅₊ streams may be separately hydrotreated to remove undesirable acetylenes and dienes.

In conventional front-end depropanizer sequences, the quenched and acid-free gases containing hydrocarbons having from one to five or more carbon atoms per molecule (C₁ to C₅₊) first enter a depropanizer. The heavy ends exiting the depropanizer consist of C₄ to C₅₊ components. These are routed to a debutanizer where the C₄ components and lighter species are taken over the top with the rest of the feed leaving as bottoms which can be used for gasoline or other chemical recovery. These streams may be separately hydrotreated to remove undesired acetylenes and dienes. The tops of the depropanizer, containing C₁ to C₃ components, may be fed to an acetylene converter and then to a demethanizer system, where the C₁ components and any remaining hydrogen are removed as an over-head. The heavy ends exiting the demethanizer system, which contains C₂ and C₃ components, are introduced into a deethanizer wherein C₂ components are taken off the top and C₃ compounds are taken from the bottom. The C₂ components are, in turn, fed to a C₂ splitter which produces ethylene as the light product and ethane as the heavy product. The C₃ stream is fed to a C₃ splitter which separates the C₃ species, sending propylene to the top and propane to the bottom.

As with the front-end demethanizer sequence, the saturated C₂ hydrocarbons and/or the saturated C₃ hydrocarbons obtained in the front-end deethanizer sequence or the front-end depropanizer sequence or a partial stream thereof may be sent as the by-product-stream to the hydrocarbon-to-hydrogen conversion process. Alternatively, the saturated C₂ hydrocarbons and/or the saturated C₃ hydrocarbons or a partial stream thereof is recycled as feed into the cracking process.

Hydrocarbon-Containing Cracker by-Product Stream

The composition of the cracked gas from which product-of-interest streams are recovered may vary within broad ranges depending on the type of cracker feed and the severity of cracking conditions. As a consequence, the composition of the by-product streams is also subject to variations. The moving bed hydrocarbon pyrolysis process has been found to be a robust and reliable technology which can accommodate fluctuations in the composition of the feed gas.

Typically, the cracked gas contains, based on the total weight of the cracked gas, the following components (other than product-of-interest streams), which may constitute the cracker by-product stream which is directed to the hydrocarbon-to-hydrogen conversion process:
hydrogen from 0.8 to 4.2 wt.-%,
methane from 2.8 to 23.5 wt.-%,
ethane from 1.9 to 35.1 wt.-%,
propane from 0.1 to 10.1 wt.-%,
butane from 0.04 to 6.1 wt.-%.

Here, only C₄ₘᵢₙᵤₛ hydrocarbons are considered. During water quench, the C₅₊ fraction, commonly referred to as pyrolysis gasoline, is separated from the cracked gas. CO₂, H₂O, sulfur compounds and nitrogen compounds are removed after the water quench via drying and caustic washing and therefore do not go any further.

In the event of naphtha as cracker feed, the cracked gas typically contains, based on the total weight of the cracked gas:
hydrogen from 0.82 to 1.06 wt.-%,
methane from 11.83 to 16.9 wt.-%,
ethane from 3.00 to 4.76 wt.-%,
propane from 0.32 to 0.68 wt.-%,
butane from 0.17 to 0.85 wt.-%.

In the event of LPG, i.e. propane and butane, as cracker feed, the cracked gas typically contains, based on the total weight of the cracked gas:
hydrogen from 1.05 to 1.68 wt.-%,
methane from 19.33 to 23.43 wt.-%,
ethane from 1.96 to 4.57 wt.-%,
propane from 0.33 to 10.07 wt.-%,
butane from 0.04 to 6.08 wt.-%.

Generally, the cracker by-product stream that is directed to the hydrocarbon-to-hydrogen conversion process contains the hydrogen and methane and can optionally also contain C₂₊ alkanes.

### Hydrocarbon-to-Hydrogen Conversion

The hydrogen product stream subjected to combustion to provide thermal energy for the cracking process is obtained from a hydrocarbon-to-hydrogen conversion process. According to the invention, one or more hydrocarbon-containing by-product-streams recovered from the cracking process are used as the feedstock of the hydrocarbon-to-hydrogen conversion process.

The “hydrogen product stream” resulting from the hydrocarbon-to-hydrogen conversion process comprises hydrogen as its main constituent. Preferably, the hydrogen product stream comprises at least 60 vol.-%, more preferably at least 70 vol.-%, most preferably at least 85 vol.-%, in particular at least 95 vol.-%, in particular at least 99 vol.-% of hydrogen when being subjected to combustion to provide thermal energy for the cracking process. Beside hydrogen, the hydrogen product stream may comprise carbon dioxide, carbon monoxide, methane, C₂₊ alkanes and/or water.

According to the invention, the hydrocarbon-to-hydrogen conversion process is a moving bed hydrocarbon pyrolysis process, preferably a moving carbon bed hydrocarbon pyrolysis process. Herein, the conventionally used term methane pyrolysis will be used in the following and is meant to be synonymous with the term “hydrocarbon pyrolysis”. Methane pyrolysis is a technology that splits hydrocarbons, especially aliphatic hydrocarbons such as methane, ethane, propane and/or butane directly into hydrogen and solid carbon. Most often, natural gas comprising methane is used as feedstock for methane pyrolysis. In accordance with this invention, a process is provided which utilizes a by-product-stream from a cracker as the feedstock for the methane pyrolysis in whole or in part. For methane, the pyrolysis proceeds according to the following main reaction:

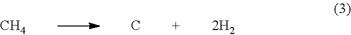

The process is moderately endothermic (about 37 kJ/mole of H₂). It is evident that in methane pyrolysis, the release of greenhouse gases is prevented. Therefore, in the event that the energy originates from renewable resources, methane pyrolysis is a CO₂-free, i.e. clean technology to obtain emission-free hydrogen. Methane pyrolysis is a one-step process which produces hydrogen in high volume.

Generally, the method comprises allowing substrate particles to flow downwardly under gravity flow as a particle bed through a reaction zone; heating the particles in the reaction zone to a temperature conducive of hydrocarbon pyrolysis; feeding a feed gas stream comprising the by-product-stream through the reaction zone in counter current to the particles flow, whereby carbon is deposited on the substrate particles; withdrawing the substrate particles having carbon deposited thereon from the reaction zone; and withdrawing the hydrogen product stream from the reaction zone.

Herein, the substrate particles are particles which act as a substrate for the deposition of carbon produced during the pyrolysis reaction. The substrate particles may be manufactured from an arbitrary support material, preferably from metals, ceramics, and mixtures thereof. The preferred substrate is a carbonaceous or carbon-containing substrate, for example pyrolytic carbon itself. The particle size of a preferred substrate is in the range of 0.1 to 10 mm, preferably 0.3 to 8 mm.

Preferably the substrates are carbonaceous materials that are macro-structured carbonaceous materials, wherein the porosity of the carbonaceous material is in the range of 30 to 70 vol.-% and the carbonaceous material contains of a carbon content of 98 to 100 wt.-%, preferably 99 to 100 wt.-%, even more preferably 99.5 to 100 wt.-% and a content of alkaline-earth metals, transition metals and metalloids of 0 to 2 wt.-%, preferably 0 to 1 wt.-%, even more preferably 0 to 0.5 wt.-%, based on the total mass of solid carbonaceous material (see WO 2023/057242).

The BET surface area of the substrate is preferably between 0.1 and 100 m²/g, preferably 0.1 and 50 m²/g, in particular 0.1 to 30 m²/g.

Preferably, the density of the substrate is in the range of 1.5 to 2.5 g/cc (real density in xylene, ISO 8004). Preferably, the bulk density of the substrate is in the range of 0.5 to 1.5 g/cc.

The methane pyrolysis is carried out in a moving-bed reactor. In a moving-bed reactor, a feed gas at least partially comprising the cracker by-product-stream, and solid substrate material particles flow in countercurrent throughout the reactor. Typically, the process comprises feeding the substrate particles to the top of the reactor, allowing the substrate particles to flow downwardly under gravity flow as a compact column, which means that the movement of the moving bed is gravity driven.

For this purpose, the reactor is preferably a vertical elongated reactor. The substrate particles are withdrawn from the reactor at the bottom of the reactor. Flow through the moving bed advantageously takes place homogeneously and uniformly (see for example WO 2013/004398, WO 2019/145279 and WO 2020/200522).

The feed gas stream is preferably introduced via the bottom of the reactor, preferably having a temperature of 10 to 60° C. The substrate particles are preferably introduced via the top of the reactor, preferably having a temperature of 10 to 60° C.

The reaction is carried out at a temperature conducive of hydrocarbon pyrolysis. Preferably, the reaction zone is operated at a temperature in the range of from 800 to 1500° C. The reaction is preferably carried out at pressures ranging from 1 to 100 bar (abs), more preferably 5 to 50 bar (abs).

The substrate particles are maintained at the reaction temperature in the reaction zone. This heat is released and transferred to the feed gas. The carbon produced in the hydrocarbon pyrolysis reaction is deposited on the substrate particles, and the substrate particles having carbon deposited thereon are continuously removed at the reactor bottom.

In a preferred embodiment, thermal energy is provided to the pyrolysis reaction by electrical heating. The use of electric energy as a heat source instead of heating by combustion of natural gas allows considerable advantages, in particular with regard to the ease of control. When the electricity comes from a non-fossil resource, the endothermic reaction can be implemented with negative emission of carbon dioxide.

The type of electrical heating is not particularly limited. If the substrate particles are electrically conductive, they may be heated by resistive heating (Joule heating), as described for example in U.S. Pat. No. 2,982,622, WO 2019/145279 and WO 2020/200522. To this end, the electrically conductive substrate particles may be heated by an electrical potential or voltage applied across at least a portion of the particle bed. Electrical power may be supplied through a plurality of electrodes that are in an electrically conductive relationship with the particle bed, e.g., immersed in the particle bed. Thus, in a preferred embodiment, the method comprises applying a voltage to the moving bed across the reaction zone to provide direct electric resistance heating.

The resistive thermal energy generated by passing a current through the particles defining the electrically conductive bed may be supplemented by other heat sources. In embodiments, additional heat can be provided to the pyrolysis by preheating the hydrocarbon that is designed to be flowed through the particle bed. In still other embodiments, additional heat can be provided by inductive heating. Optionally, additional resistive heating elements may be used. The additional heating elements can take the shape of a wire, ribbon, sheet or strip and can be straight, meandering or coiled. Such a heating element converts electricity into heat through the process of Joule heating.

The hydrogen product stream is preferably recovered via the top of the reactor, preferably having a temperature of 10 to 200° C. The substrate particles having carbon deposited thereon are preferably recovered via the bottom of the reactor, preferably having a temperature of 10 to 200° C. Discharging the particles may be accomplished by conventional discharge means, e.g., by a cellular wheel sluice.

The discharged carbon may be at least partly recycled and introduced into the reactor again using it as substrate for the moving bed, optionally after a treatment such as grinding or activation. As a result, a continuous process of the moving bed is achieved.

The flow velocity of the substrate particles is advantageously in the range of 0.005 to 0.5 cm/s. The flow velocity of the by-product-stream is advantageously in the range of 0.025 to 2 m/s.

The gas residence time in the reactor is advantageously between 0.5 and 50 s, preferably between 1 and 10 s. Such relatively high residence times advantageously allow for reduced formation of by-products in the hydrogen product stream. The residence time of the substrate particles is preferably between 0.5 and 15 hours, preferably between 1 and 10 hours and more preferably between 2 and 8 hours.

Carrying out the methane pyrolysis at said reaction conditions advantageously allows for obtaining solid carbon besides a hydrogen-containing stream which is essentially free of impurities. In this context, the term “essentially free” denotes that the hydrogen-containing stream comprises only trace amounts of impurities such as methane and/or polycyclic carbonaceous species. Preferably, the hydrogen-containing stream comprises hydrogen in an amount of 85 to 100 vol.-%, more preferably 90 to 98 vol.-%, most preferably 90 to 96 vol.-%.

In a preferred embodiment, the method additionally comprises subsequently guiding the particles through a first heat integration zone located above the reaction zone, the reaction zone, and a second heat integration zone located below the reaction zone; transferring heat from the hydrogen product gas leaving the reaction zone to the substrate particles in the first heat integration zone by direct heat transfer; and transferring heat from substrate particles leaving the reaction zone to the by-product-stream in the second heat integration zone.

The gaseous hydrogen product stream is cooled down at the reactor top upon contact with the cold fresh substrate particles. As a consequence, the substrate particles are preheated by the outlet gas before entering the reaction zone and being heated. Likewise, the feed gas is preheated by contact of the substrate particles leaving the reaction zone. Thus, the thermal energy is substantially stored in the particle bed. Heat recovery rates of more than 95% of the sensible heat may be accomplished by the present method.

There is an uninterrupted particle flow through the first heat integration zone, the reaction zone and the second heat integration zone.

Heat exchange in the heat integration zones can be optimized by varying the downward flow velocity of the substrate particles and/or the volume flow of the cracker by-product-stream to the reactor. The mass flow of solid and gas are adjusted to have the same heat capacity. With this measure, heat is recovered and loss through hot gas/solid streams leaving the reactor are minimized.

In a preferred embodiment, the method comprises combining the by-product stream with an extender fluid prior to being subjected to the hydrocarbon-to-hydrogen conversion process. When the cracker by-product-stream contacts the hot substrate particles, it is cracked, and carbonaceous material, such as coke, is formed. This newly formed material is extremely adhesive. Most of this material will deposit on the surface of the moving particles in the particle bed. However, there is a risk of the formation of agglomerates of particles that may result in plugs. This is particularly true for cracker by-product-streams that contain significant amounts of C₂₊ hydrocarbons.

The extender fluid dilutes the cracker by-product-stream and increases the momentum of the cracker by-product-stream in a direction that is substantially axial to the pyrolysis reactor. Thereby the pyrolysis reaction is at least partly shifted away from the feed point of the cracker by-product-stream and the reaction is made more uniform over the volume of the reactor.

The use of an extender fluid hence enables to cope with various kinds of cracker by-product-streams including those with significant amounts of C₂₊ hydrocarbons; the ability to use lower pressures for feedstock introduction; and/or other benefits.

The extender fluid is substantially chemically inert to hydrocarbons. The extender fluid can be at least one inert gas, e.g., argon, neon, helium, and the like. Preferably however, the extender fluid is hydrogen. Most preferred the extender fluid is a partial stream of the hydrogen product stream that is recycled. Preferably, the recycled partial stream of the hydrogen product stream is used without any purification steps. The recycled partial stream of the hydrogen product stream may be cooled, heated and/or compressed.

Varying the recycle ratio of the hydrogen product stream allows for pyrolysis process control that may be required when cracker operation is shifted to different types of cracker feedstock and/or cracking conditions.

In a preferred embodiment, the process comprises determining an optimized process operation point based on an optimal heat integration which, in turn, is dependent on the hydrocarbon concentration, the substrate used and the deposition rate of the solid carbon. Determination of an optimized process operation point may be based on additional factors such as reliability, safety, and environmental process operational constraints. The operation point is characterized by a fixed hydrogen to hydrocarbon ratio in the feed stream. If the composition of the cracker by-product stream deviates from the fixed hydrogen to hydrocarbon ratio, a dedicated amount of hydrogen product stream could be recycled to adjust the ratio.

Preferably, the operation point of the pyrolysis unit is set between 70 and 99 vol.-% hydrogen and 1 and 30 vol.-% hydrocarbons related to the total volume of the raw natural, golden hydrogen-hydrocarbon mixture. Due to the fact that the feed concentration of the reactor could be controlled by the internal hydrogen recycle there is a broad range for the concentration of hydrogen in the cracker by-product stream applicable.

Preferably, the operation point is set to the highest hydrogen concentration expected in the cracker by-product stream. If a dilution, e.g. a hydrogen dilution, of the cracker by-product stream is needed to reach the set operation point, a recycled hydrogen product stream is used for such dilution. In other words, Preferably, the recycled partial stream of the hydrogen product stream is measured before feeding it into the pyrolysis unit. Depending on the difference of said concentration to the operation point, the direct hydrogen product stream recycle is increased or decreased. Optionally, additional hydrogen is added to the pyrolysis unit for adjusting the concentration to the operation point. Optionally, additional hydrocarbons, like natural gas or biomethane, are added to the pyrolysis unit for adjusting the concentration to the operation point.

Preferably, the feed for the hydrocarbon-to-hydrogen conversion process containing the hydrocarbon-containing by-product-streams has a fixed H₂/CH₄ feed molar, the operation point. The operation point enables an optimal heat integration and is dependent on the hydrocarbon concentration, the substrate used and the deposition rate of the solid carbon. To adjust the feed concentration, a dedicated amount of hydrogen could be recycled.

Preferably, the operation point of the hydrocarbon-to-hydrogen conversion process is set between 70 and 99 vol.-% hydrogen and 1 and 30 vol.-% hydrocarbons related to the total volume of the hydrocarbon-containing by-product-streams. Due to the fact that the feed concentration of the hydrocarbon-to-hydrogen conversion process could be controlled by the internal hydrogen recycle there is a broad range for the concentration of hydrocarbons applicable.

Preferably, if a hydrogen dilution of the hydrocarbon-containing by-product-streams is needed to reach the set operation point, a recycled hydrogen product stream is used for such dilution. Preferably, a direct hydrogen product stream recycle is used, that means, a portion of the raw hydrogen product stream is recycled, preferably without any purification steps. Said recycled hydrogen stream may or may not be cooled, heated and/or compressed.

Preferably, the hydrogen and/or hydrocarbon concentration of the hydrocarbon-containing by-product-streams is measured before feeding it into the hydrocarbon-to-hydrogen conversion process. Depending on the difference of said concentration to the operation point, the direct hydrogen product stream recycle is increased or decreased. Optionally, additional hydrogen is added to the hydrocarbon-to-hydrogen conversion process for adjusting the concentration to the operation point. Optionally, additional hydrocarbons, like natural gas or biomethane, are added to the hydrocarbon-to-hydrogen conversion process for adjusting the concentration to the operation point.

A further advantage of methane pyrolysis is that the obtained solid carbon can be sold as a commercial product for selected applications, depending on the carbon morphology and physical/chemical properties. For example, the solid carbon from methane pyrolysis may be used for aluminum and steel production, tire manufacturing, electrode manufacturing, polymer blending, additive for construction materials, carbon devices like heat exchangers, soil conditioning, or storage.

### Pyrolytic Granular Carbon

Typically, the density of granular pyrolytic carbon produced by methane pyrolysis is in the range of 1.5 to 2.5 g/cc, preferably 1.8 to 2.3 g/cc (real density in xylene, ISO 8004). Typically, the bulk density of the granular pyrolytic carbon is in the range of 0.5 to 1.5 g/cc, more preferably 0.7 to 1.3 g/cc.

Typically, the ash content of the granular pyrolytic carbon is in the range of 0.001 to 1 wt.-%, preferably 0.01 to 0.2 wt.-%, of the composition.

Typically, the carbon content of the granular pyrolytic carbon is in the range of 98 to 100 wt.-%, more preferably 99.5 to 100 wt.-%, even more preferably 99.75 to 100 wt.-%, even more preferably 99.9 to 100 wt.-%.

Typically, the impurities of the granular pyrolytic carbon are: S in the range of 0 to 0.5 wt.-%, more preferably 0 to 0.1 wt.-%, Fe in the range of 0 to 1000 ppm, preferably 0 to 500 ppm, Ni in the range of 0 to 250 ppm, preferably 0 to 100 ppm, V in the range of 0 to 250 ppm, more preferably 0 to 100 ppm, Na in the range of 0 to 200 ppm, preferably 0 to 100 ppm. Oxygen is in the range of 0 to 100 ppm, preferably below the detection limit.

Typically, 90 wt.-% of the carbon of the granular pyrolytic carbon is not-functionalized, preferably 95 wt.-%, even more preferably 98 wt.-%, especially 99 wt.-%, wherein carbon functionalization refers to a reaction in which a carbon-carbon bond is broken and replaced by a carbon-X bond (where X is usually hydrogen, oxygen, sulfur, phosphorus, nitrogen, halogens, and/or metals).

Typically, the cation exchange capacity (CEC) of granular pyrolytic carbon is about 0.01 to 1.5 cmol/kg, preferably 0.025 to 0.75 cmol/kg.

Typically, the particle size of the granular pyrolytic carbon directly resulting of the decomposition of gaseous hydrocarbons—without any agglomeration step—is in the range of 0.3 mm (d10) to 8 mm (d90), preferably 0.5 mm (d10) to 5 mm (d90), more preferably 1 mm (d10) to 4 mm (d90).

Typically, the porosity of the granular pyrolytic carbon is between 0 and 15%, preferably 0.2 and 10%, more preferably 0.2 and 5% (Hg porosimetry, DIN66133).

Typically, the specific surface area of the granular pyrolytic carbon measured by Hg porosimetry (DIN66133) is in the range of 0.001 to 10 m²/g, preferably 0.001 to 5 m²/g, even more preferably 0.05 to 2 m²/g.

In view of energy cycle management, it is advantageous that the solid carbon from methane pyrolysis may also be used as carbon which can directly be transported or stored without any safety risks. For this purpose, said (granular) carbon obtained from methane pyrolysis may be transported, without any safety risks, to a production site other than methane pyrolysis for being reacted with a source of hydrogen, e.g. obtained from water electrolysis. The resulting hydrocarbons may subsequently be fed into a gas grid or used elsewhere.

As the energy demand of the methane pyrolysis contributes to the energy-penalty of the carbon fixture, a methane pyrolysis process having a high as possible energy efficiency is preferred. Moving carbon bed methane pyrolysis is especially advantageous due to its low energy demand and its higher hydrogen yields as compared to other methane pyrolysis methods such as methane pyrolysis conducted catalytically or thermally, with heat input via plasma, liquid metal or micro-wave processes or autothermal. The methane pyrolysis is not limited to a specific energy supply, preferably the pyrolysis is electrically heated.

### Providing Thermal Energy to the Cracking Process

Conversion of saturated hydrocarbons to olefins is highly endothermic. Thus, cracking is a very energy intense petrochemical process. The cracking furnaces are the largest fuel consumers in a cracking plant. While the light saturated hydrocarbons from the cracker, e.g. comprising methane, may be fired directly for generating thermal energy, firing the light saturated hydrocarbons results in the production of carbon dioxide which is disadvantageous in view of an operation of the process under a reduced carbon footprint. It is apparent that providing at least a part of the required energy for this process in the form of “clean” thermal energy, i.e. energy produced with a reduced CO₂ footprint, instead of energy originating from firing the light saturated hydrocarbons would be advantageous.

Therefore, the method of the present invention further comprises a hydrocarbon-to-hydrogen conversion process step yielding a hydrogen product stream which is subsequently at least partially combusted to provide thermal energy to the cracking process. As described above, the combustion of at least part of the hydrogen product stream ideally yields water as the only by-product instead of carbon dioxide and is therefore particularly advantageous in view of reducing carbon dioxide emissions, or, in other words, for reducing the carbon footprint of this process.

Heat may be recovered from the steam formed as the exhaust gas of the hydrogen combustion. Thus, the steam may be expanded into a gas turbine or used as an energy source in other plants. Owing to its purity, the steam condensate may be directed to various uses.

For combustion, at least part of the hydrogen product stream is mixed with oxygen and combusted in burners or heating coils of the cracking process. In addition to oxygen, water and/or methane may be added to the fuel. In case methane is added to the fuel, it is preferable to avoid methane separation from the reformed stream or the shifted stream.

The portion of the hydrogen product stream which is not subjected to combustion to provide thermal energy to the cracking process may be stored or transported for use elsewhere. Hence, it is preferably introduced into a hydrogen transportation network and/or used in hydrogenation reactions such as CO₂ hydrogenation to methanol.

Separation of the hydrogen product stream into parts which are subjected to combustion to provide the thermal energy to the cracking process and parts which are introduced into a hydrogen transportation network and/or are used in hydrogenation reactions can be achieved by means known in the art, such as controlled valves.

Preferably, the amount of the hydrogen product stream which is subjected to combustion to provide thermal energy for the cracking process is in the range of from 50 to 100%, more preferably 80 to 100%, most preferably 95 to 100%.

In the case that at least a part of the thermal energy to operate the cracking process is provided by means of electrical energy, respectively by electricity, the amount of the hydrogen product stream subjected to combustion to provide thermal energy to the cracking process is reduced accordingly.

### Integration of Externally-Derived Energy Carriers

The method of the invention enables the use of various energy carriers depending on their availability.

In a preferred embodiment, the method of the invention comprises adding a methane rich stream to the by-product-stream to form a combined stream and subjecting the combined stream to the hydrocarbon-to-hydrogen conversion process. The term “methane rich stream” denotes a stream consisting predominantly or exclusively of methane, for example a gas having a methane content of at least 50 vol.-%, the remainder being hydrocarbons other than methane or inert gases having no caloric value. A preferred methane rich stream is natural gas. This measure may be necessary in cases where the hydrocarbon-to-hydrogen conversion process of the by-product-stream does not yield an amount of hydrogen which is sufficient to provide enough thermal energy to the cracking process by hydrogen combusting. By adding a methane rich stream, i.e. a further source of energy, to the by-product-stream, a combined stream may be obtained, in which the amount of methane available for the hydrocarbon-to-hydrogen conversion process, e.g. for reforming, is increased. This advantageously allows for the production of sufficient hydrogen such that hydrogen can be used as the sole fuel for providing thermal energy to the cracking process and no additional methane needs to be combusted in the furnace of the cracking process.

The resulting process is still an emission-reduced operation of a cracking process. It involves the reduction of CO₂ emissions from the thermal utilization of the natural gas stream by pre-combustion carbon capture. Thus, carbon dioxide is removed from the reformed stream or from the shifted product stream or captured as solid carbon during methane pyrolysis.

In a preferred embodiment, the method of the invention comprises adding a bio-based gas stream to the by-product-stream to form the combined stream and subjecting the combined stream to the hydrocarbon-to-hydrogen conversion process. In contrast to the above-mentioned embodiment, the additional source of energy added to the by-product-stream to obtain the combined stream is bio-based gas, i.e. a non-fossil, renewable source of energy.

The term “bio-based gas” encompasses is a mixture of gases, primarily consisting of methane besides carbon dioxide and hydrogen sulfide which is produced from raw materials such as agricultural waste, manure, municipal waste, plant material, sewage, green waste, food waste etc. Thus, bio-based gas is a renewable source of energy.

This results in an even more emission-reduced operation or even negative carbon-footprint operation of a cracking process as one part of the energy used for firing the cracking process stems from “clean” hydrogen, i.e. produced with a reduced CO₂ footprint, obtained by hydrocarbon-to-hydrogen conversion process, and another part of the energy stems from bio-based gas as a non-fossil, renewable source of energy.

Alternatively or additionally to the aforementioned embodiments, the method of the invention comprises adding additional hydrogen to the hydrogen product stream. This measure may be advantageous in cases where a hydrogen stream is readily available from an external source.

The resulting process is still an emission-reduced operation of a cracking process as at least part of the energy used for firing the cracking process stems from a “clean” source of energy, i.e. energy produced with a reduced CO₂ footprint, e.g. from the hydrogen obtained by hydrocarbon-to-hydrogen conversion process.

The additional hydrogen may be obtained from an ammonia splitting process, from methane pyrolysis, waste gasification and/or via water electrolysis.

In the event that the additional hydrogen stems from methane pyrolysis or water electrolysis, e.g. water electrolysis using renewable energy, this results in an even more emission-reduced operation of a cracking process.

In a preferred embodiment, the method of the invention comprises providing at least a part of the thermal energy required for the operation of the cracking process by means of electrical energy, preferably electricity. More preferably, the electrical energy and electricity originates from renewable sources.

In case where the electrical energy, respectively electricity originates from renewable sources, an even more emission-reduced operation of a cracking process is achieved.

In case when additional hydrogen is readily available from an external sources as mentioned above and/or when at least part of thermal energy required to operate the cracking process is provided by means of electrical energy, it is preferred to use at least a part of the reformed stream, precisely the synthesis gas contained in the reformed stream, to produce chemicals like methanol, ethanol or aldehydes in hydroformylation reactions of olefins. In such an embodiment, the reformed stream or parts of the reformed stream are not subjected to a water gas shift process and synthesis gas is separated from the reformed stream and further used to produce chemicals.

The invention is further illustrated by the appended FIGURE and the examples that follow.

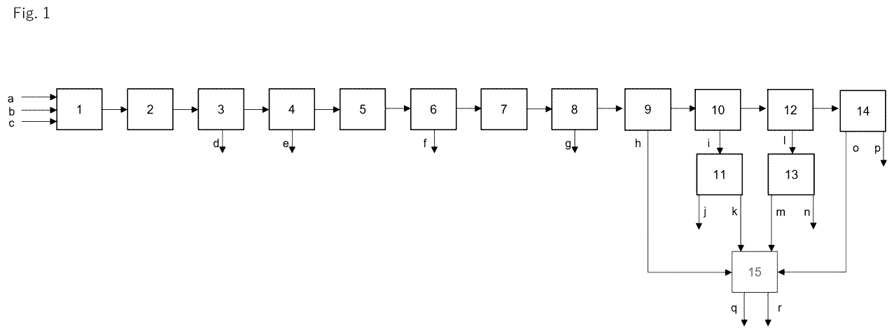

FIG. 1 is a flow chart of the process of the invention.

While the order that the compounds are removed may vary from plant to plant, the general flow can be seen in FIG. 1. A feed stream a, e.g., naphtha, steam b and an optional recycle stream c enter the cracking unit 1. After the cracked gas emanating from the cracking unit 1 has been cooled in heat exchanger 2, an oil quench 3 and water quench 4 and compressed in compressor 5, it is subjected to acid wash 6. Heavy residues d (general: C₁₀₊) and pyrolysis gasoline e (general: C₅-C₉) are separated out in oil quench 3 and water quench 4, respectively. A stream f of sulfur compounds and CO₂ is separated in acid wash 6 by a caustic wash liquid. After being compressed by compressor 7 the gas is dried in gas drying unit 8. Water g is removed in gas drying unit 8. The cracked gas then enters the demethanizer 9 to remove the methane and lighter compounds h. These light compounds leave the overhead of the demethanizer and are directed to moving bed reactor 15.

The bottom of the demethanizer enters the deethanizer 10. The C₂s exit the overhead of the deethanizer 10 and enter a C₂ splitter fractionator 11 that separates the ethylene j from the ethane k. The ethylene j is sold as product and the ethane k may be directed to moving bed reactor 15 along the overhead h of the demethanizer 9. The remainder of the cracked gas leaves the bottom of the deethanizer 10 and is fed into the depropanizer 12. At the depropanizer 12, the C₃ compounds are sent out the top. The C₃s then enter the C₃ splitter fractionator 13 to separate the propylene n from the propane m. The propane m may be directed to moving bed reactor 15 along the overhead h of the demethanizer 9. The last of the cracked gas enters the butylene splitter 14 to separate out the C₄ olefins p leaving butane o which exits the bottom of the butylene splitter 14. The butane o may be directed to moving bed reactor 15 along the overhead h of the demethanizer 9.

Carbon q and hydrogen r are the products of the moving bed reactor 15. The hydrogen may be combusted to provide thermal energy to the cracking unit 1.

### EXAMPLES

Methane pyrolysis was performed in a laboratory-scale fixed-bed reactor setup with inner tube diameter of 50 mm and a length of the fixed-bed of 0.5 m. In the center of the fixed-bed, another tube with outer diameter of 10 mm is positioned, which is equipped for measurement of temperature. For pyrolysis, the reactor tube was heated externally to 1450° C.

Example 1: Pyrolysis was performed at a volume flow of methane of 220 NI/h, diluted in hydrogen and argon.

Example 2: Pyrolysis was performed at a volume flow of methane of 220 NI/h (91.7%) and ethane of 20 NI/h (8.3%), diluted in hydrogen and argon.

TABLE 1
Change in product mass flow normed to the total
mass flow of hydrocarbons in the product gas.

| Measured hydrocarbons | Delta of product mass |
|---|---|
| in the product gas | between example 2 and 1 |
| Delta CH₄ | 1.936% |
| Delta C₂H₆ | −0.040% |
| Delta C₂H₄ | 0.000% |
| Delta C₂H₂ | −0.245% |
| Delta C₃H₆ | 0.009% |
| Delta C₆H₆ | −0.026% |

TABLE 2
Change in conversion rate of hydrocarbons.

| | |
|---|---|
| Delta conversion normed to total | 7.3% |
| hydrocarbon feed between example 2 | |
| and 1 | |

The composition of the hydrocarbons in the product gas in example 1 and 2 was almost identical. The conversion rate of example 2 is significantly higher than the conversion rate of example 1. Therefore, the ethane shares in the feed gas of example 2 was almost completely converted to hydrogen and solid carbon. This shows that the moving bed hydrocarbon pyrolysis process is capable of converting higher hydrocarbons than methane, i.e. C2 hydrocarbons such as ethane.

1.-20. (canceled)

21. A method for operating a cracking process which produces a cracked gas from which one or more product streams and one or more hydrocarbon-containing by-product-streams are recovered, the method comprising:
subjecting at least one of the by-product-streams or a partial stream thereof to a hydrocarbon-to-hydrogen conversion process to produce a hydrogen product stream; and
combusting at least a part of the hydrogen product stream to provide thermal energy to the cracking process,
wherein the hydrocarbon-to-hydrogen conversion process is a moving bed hydrocarbon pyrolysis process.

22. The method of claim 21, comprising recovery of the product streams from the cracked gas by a series of distillation steps including at least one demethanizer, in which methane and lighter fractions are separated as an over-head stream, optionally separating the over-head stream to obtain a hydrogen rich stream and a methane rich stream, and
subjecting the over-head stream or the methane rich stream or partial streams thereof as the by-product-stream to the hydrocarbon-to-hydrogen conversion process.

23. The method of claim 21, comprising recovery of the product streams from the cracked gas by a series of distillation steps including a separation of saturated and unsaturated C₂ hydrocarbons in a C₂ splitter and/or separation of saturated and unsaturated C₃ hydrocarbons in a C₃ splitter, and
subjecting the saturated C₂ hydrocarbons and/or the saturated C₃ hydrocarbons or a partial stream thereof as the by-product-stream to the hydrocarbon-to-hydrogen conversion process.

24. The method of claim 21, involving a quench of hot cracked gas with a high-boiling liquid, wherein a heavy stream comprising C₁₀₊ hydrocarbons is separated from the cracked gas, and a water quench, wherein pyrolysis gasoline is separated from the cracked gas,
optionally subjecting the pyrolysis gasoline to hydrogenation,
optionally subjecting the hydrogenated pyrolysis gasoline to extractive separation of benzene, and subjecting at least one of the heavy stream, the pyrolysis gasoline, the hydrogenated pyrolysis gasoline and the benzene-depleted hydrogenated pyrolysis gasoline or a partial stream thereof as the by-product-stream to the hydrocarbon-to-hydrogen conversion process.

25. The method of claim 21, wherein the by-product-stream includes methane.

26. The method of claim 21, wherein the moving bed hydrocarbon pyrolysis process is a moving carbon bed hydrocarbon pyrolysis process.

27. The method of claim 21, comprising
allowing substrate particles to flow downwardly under gravity flow as a particle bed through a reaction zone;
heating the particles in the reaction zone to a temperature conducive of hydrocarbon pyrolysis;
feeding a feed gas stream comprising the by-product-stream through the reaction zone in counter current to the particles flow, whereby carbon is deposited on the substrate particles;
withdrawing the substrate particles having carbon deposited thereon from the reaction zone; and
withdrawing the hydrogen product stream from the reaction zone.

28. The method of claim 21, wherein substrate particles contained in the moving bed are selected from carbonaceous materials, metals, ceramics, or a mixture thereof.

29. The method of claim 21, wherein the moving bed hydrocarbon pyrolysis process is electrically heated.

30. The method of claim 21, wherein the reaction zone is operated at a temperature in the range of from 800 to 1500° C. and at a residence time of at least 1 s.

31. The method of claim 21, additionally comprising
subsequently guiding the particles through a first heat integration zone located above the reaction zone, the reaction zone, and a second heat integration zone located below the reaction zone;
transferring heat from the hydrogen product gas leaving the reaction zone to the substrate particles in the first heat integration zone by direct heat transfer; and
transferring heat from substrate particles leaving the reaction zone to the by-product-stream in the second heat integration zone.

32. The method of claim 21, comprising applying a voltage to the moving bed across the reaction zone to provide direct electric resistance heating.

33. The method of claim 21, comprising combining the by-product stream with an extender fluid prior to being subjected to the hydrocarbon-to-hydrogen conversion process.

34. The method of claim 33, wherein the extender fluid is a partial stream of the hydrogen product stream that is recycled.

35. The method of claim 21, comprising adding a methane rich stream to the by-product-stream to form a combined stream and subjecting the combined stream to the hydrocarbon-to-hydrogen conversion process.

36. The method of claim 21, comprising adding a bio-based gas stream to the by-product-stream to form the combined stream and subjecting the combined stream to the hydrocarbon-to-hydrogen conversion process.

37. The method of claim 21, comprising adding additional hydrogen to the hydrogen product stream, wherein the additional hydrogen is preferably obtained from an ammonia splitting process, from methane pyrolysis, waste gasification, and/or via water electrolysis.

38. The method of claim 21, wherein the cracking process is a steam cracking process.

39. The method of claim 21, wherein the hydrocarbon subjected to the cracking process is selected from natural gas, recyclate, bio-based gas, ethane, propane, butane naphtha, bio-naphtha, liquefied petroleum gas (LPG), or bio-liquefied petroleum gas (bio-LPG).

40. The method of claim 21, comprising providing at least a part of the thermal energy required for the operation of the cracking process by means of electrical energy.
